(19) United States
(12) Patent Application Publication
(10) Pub. No.: US 2024/0188587 A1
(43) Pub. Date: Jun. 13, 2024

(54) PLANT BASED SCHNITZEL PRODUCT

(71) Applicant: SOCIETE DES PRODUITS NESTLE S.A., Vevey (CH)

(72) Inventors: PATRICK PIBAROT, Territet (CH); LAURA HERZ, Lausanne (CH); ROMAIN DAVAILLE, Vers L Eglise (CH); NICOLAS PINEAU, Auboranges (CH); ANTHONY LIMA, Les Hopitaux Neufs (FR); CINDY PELLOUX, Champanges (FR)

(21) Appl. No.: 18/552,995

(22) PCT Filed: Apr. 6, 2022
(86) PCT No.: PCT/EP2022/059134

§ 371 Date: Sep. 28, 2023

(30) Foreign Application Priority Data
Apr. 6, 2021 (EP) 21167036.9
Jun. 30, 2021 (EP) 21182991.6

(51) Int. Cl. A23J 3/26; A23J 3/16; A23J 3/18; A23J 3/22; A23P 20/12

(52) U.S. Cl. CPC A23J 3/26; A23J 3/16; A23J 3/18; A23J 3/227; A23P 20/12

(57) ABSTRACT

The invention relates to a plant based schnitzel product, said product comprising a plant protein based extrudate comprising at least two different plant proteins: a breaded coating surrounding the plant protein based extrudate: and wherein said plant protein based extrudate comprises fibres which are aligned in substantially the same direction and wherein the plant protein based extrudate is present as a single extruded slab or as a layer of two or more extruded slabs.

Schnitzel is well known as a popular German tendered meat preparation. Several recipes include Wiener-Schnitzel made with veal, Schweine-Schnitzel made with pork, Puten-Schnitzel made with turkey, and Hänchen-Schnitzel made with chicken.

Recent years have seen a strong consumer trend towards plant based versions of meat based products. Plant based schnitzels do exist on the market. Most are made with texturized vegetable protein which involve grinding of extrudates into small pieces and gluing together with binder. In general, current products on the market have a texture and mouthfeel which is significantly different from meat based schnitzels.

Products on the market typically have a long list of ingredients including thickener (xanthan gum), binder (methyl cellulose, maltodextrin), and preservatives. Such ingredients are not well perceived by consumers.

There is a clear need to provide plant based schnitzels which have an improved real meat texture and a short, clean label ingredient list.

### SUMMARY OF INVENTION

The invention relates in general to plant based schnitzel products.

More specifically, the invention relates to plant based schnitzel products comprising plant protein based extrudate.

More specifically, the plant based schnitzel product comprises a plant protein based extrudate comprising at least two different plant proteins.

More specifically, the plant based schnitzel product comprises a plant protein based extrudate comprising at least two different plant proteins and a breaded coating surrounding the plant protein based extrudate.

More specifically, the plant based schnitzel product comprises a plant protein based extrudate comprising at least two different plant proteins and a breaded coating surrounding the plant protein based extrudate, wherein said plant protein based extrudate comprises fibres which are aligned in substantially the same direction. Preferably, greater than 50% of the fibres are aligned in substantially the same direction. Preferably the fibres are bundled into bundles having a length of more than one millimeter and a thickness of between 5 to 500 micro meters Preferably, the plant protein based extrudate is obtained using a coat hanger die, preferably, a 3-dimensional coat hanger die, most preferably a short 3-dimensional coat hanger die.

In one embodiment, the plant protein extrudate is present as a single extruded slab. In one embodiment, the plant protein extrudate is present as a layer of two or more extruded slabs.

Preferably, the single extruded slab or layer of two or more extruded slabs have a thickness between 5 to 20 mm. For example, a layer of three extruded slabs may have a thickness of about 16 mm, or a layer of two extrudate slabs may have a thickness of about 10 mm.

In one embodiment, the ratio of nominal maximal force values required to cut the product perpendicular to the fibre direction compared to parallel or along the fibre direction is greater than 1.55, preferably greater than 2.

In one embodiment, the product has a sensory fibrous attribute score greater than 2.5. In one embodiment, the product has a compact score of less than 1.2. In one embodiment, the product has a chewy score of more than 2.3.

In one embodiment, a binding agent is present between the layer of two or more extruded slabs.

In one embodiment, one of the at least two different plant proteins is wheat gluten. In one embodiment, one of the at least two different plant proteins is a pea protein, preferably a pea protein isolate. Preferably the wt % ratio of wheat gluten to pea protein is 30:70. In one embodiment, the at least two different plant proteins are wheat gluten and pea protein, preferably pea protein isolate, or soy protein, preferably soy protein concentrate. In one embodiment, the extrudate comprises 5 to 15 wt % wheat gluten, preferably about 12.5 wt % wheat gluten. In one embodiment, the extrudate comprises 19 to 29 wt % (preferably about 26.5 wt %) pea protein, preferably pea protein isolate, or soy protein, preferably soy protein concentrate. In one embodiment, the extrudate comprises 2.0 to 6.0 wt %, preferably about 4.0 wt % of a 10 wt % vinegar solution, or equivalent thereof.

In one embodiment, the plant protein based extrudate further comprises insoluble particles, for example calcium carbonate. In one embodiment, the extrudate comprises between 0.5 to 10 wt %, or 2 to 10 wt % precipitated calcium carbonate. The calcium carbonate is preferably precipitated calcium carbonate.

In one embodiment, the plant protein extrudate further comprises flavoring.

In one embodiment, the product of the invention is additive free.

In one embodiment, the product of the invention is free from animal products.

The invention further relates to a plant based schnitzel product comprising a plant protein based extrudate comprising at least two different plant proteins and a breaded coating surrounding the plant protein based extrudate. Preferably, one of the at least two different plant proteins is wheat gluten. In one embodiment, one of the at least two different plant proteins is a pea protein, preferably a pea protein isolate. Preferably the wt % ratio of wheat gluten to pea protein is 30:70. In one embodiment, the at least two different plant proteins are wheat gluten and pea protein, preferably pea protein isolate, or soy protein, preferably soy protein concentrate. In one embodiment, the extrudate comprises 5 to 15 wt % wheat gluten, preferably about 12.5 wt % wheat gluten. In one embodiment, the extrudate comprises 19 to 29 wt % (preferably about 26.5 wt %) pea protein, preferably pea protein isolate, or soy protein, preferably soy protein concentrate. In one embodiment, the extrudate comprises 2.0 to 6.0 wt %, preferably about 4.0 wt % of a 10 wt % vinegar solution, or equivalent thereof.

In one embodiment, the plant protein based extrudate further comprises insoluble particles, for example calcium carbonate. In one embodiment, the extrudate comprises between 0.5 to 10 wt %, or 2 to 10 wt % precipitated calcium carbonate. The calcium carbonate is preferably precipitated calcium carbonate.

In one embodiment, the plant protein extrudate further comprises flavoring.

In one embodiment, the product of the invention is additive free.

In one embodiment, the product of the invention is free from animal products.

The invention further relates to a method of making a plant based product comprising at least two different plant proteins.

More specifically, the method of making a plant based schnitzel product comprises feeding an extruder barrel with a composition comprising at least two different plant proteins and water; and extruding the composition.

More specifically, the method of making a plant based schnitzel product comprises feeding an extruder barrel with a composition comprising at least two different plant proteins and water; and extruding the composition at a temperature between 130 to 190° C.

More specifically, the method of making a plant based schnitzel product comprises feeding an extruder barrel with a composition comprising at least two different plant proteins and water; and extruding the composition at a temperature between 130 to 190° C.; cooling the composition through a die; cutting the composition to form a slab; cooking the slab or arranged layer of slabs to form a cooked slab; applying a breaded coating to the cooked slab or cooked arranged layers of slab; and optionally molding.

More specifically, the method of making a plant based schnitzel product comprising the use of a short die.
A short die is defined as a die in which L/πD ratio is less than 1, wherein L is the die length And πD is the average exit perimeter. The L/πD ratio defines the length divided by average exit perimeter (πD with D=(d1+d2)/2). The stresses are applied in the direction and perpendicular to the flow direction of the dough, respectively for L and πD. Typically, the L/πD ratio is between 0.1 to 0.99, or about 0.45, or about 0.513, or about 0.53.

The method comprises feeding an extruder barrel with a composition comprising at least two different plant proteins and water; extruding the composition at a temperature between 130 to 190° C.; cooling the composition through a die; cutting the composition to form a slab; cooking the slab or arranged layer of slabs to form a cooked slab; applying a breaded coating to the cooked slab or cooked arranged layers of slab; and optionally molding. Preferably, the breaded coating is deep fried.

In an embodiment, the die is a cooling die, for example a cooling die as described herein. In one embodiment, the cooling die is a short die, wherein the short die has a circular slit having a diameter greater than the length of the die. The length is the distance between the die entry and the slit exit. In one embodiment, the short die has a cylindrical channel. Preferably, the die comprises an extension chamber situated before the slit exit.

In an embodiment, one of the at least two different plant proteins is wheat gluten. In one embodiment, one of the at least two different plant proteins is a pea protein, preferably a pea protein isolate, or a soy protein, preferably a soy protein concentrate. In one embodiment, the at least two different plant proteins are wheat gluten and pea protein, preferably pea protein isolate. Typically, over 90%, more preferably over 95%, most preferably substantially all of the plant protein based extrudate is made up of wheat gluten and pea protein.

In one embodiment, the at least two different plant proteins are wheat gluten and soy protein, preferably soy protein concentrate. Typically, over 90%, more preferably over 95%, most preferably substantially all of the plant protein based extrudate is made up of wheat gluten and soy protein.

In an embodiment, the composition comprises between 55 to 65 wt % water.

In an embodiment, the slab or arranged layer of slabs are compressed prior to or during cooking.

In an embodiment, a binding solution is applied between the arranged layer of slabs.

In an embodiment, the binding solution comprises soy protein isolate, preferably about 12% soy protein isolate and about 10% transglutaminase in a 1:1 mixture.

In an embodiment, the binding solution comprises soy protein isolate, wheat flour and starch. In an embodiment, the binding solution comprises fibers.

In an embodiment, flavoring is added with the binding solution or by injecting into the slab. In an embodiment, flavoring is added during the coating of slabs, before breading.

In an embodiment, the slabs are cooked at about 45° C. and then at about 90° C.

The invention further relates to a plant based schnitzel product made by a method according to the invention.

In an embodiment, the product comprises a slab or arranged layer of slabs having a structure composed of long fibres organized in fibres bundles which are separated by voids.

In an embodiment, the fibres have an intermediate elasticity.

### DETAILED DESCRIPTION OF EXAMPLE EMBODIMENTS

Detailed embodiments of methods, products, and uses are disclosed herein. However, it is to be understood that the disclosed embodiments are merely exemplary and may be embodied in various forms. Therefore, specific functional details disclosed herein are not to be interpreted as limiting, but merely as a basis for the claims as a representative example for teaching one skilled in the art to variously employ the present disclosure. Features from product, method and use embodiments of the invention may be freely combined.

As used herein, “aligned in substantially the same fiber direction” should be taken to mean that greater than 50% of sheared fibers are aligned in the same direction +/−15 degrees. “Substantially equidistant from the inside of the insert” should be taken to mean that greater than 80%, more preferably 90%, most preferably all of the points on the core periphery at the widest diameter of the core are equidistant from the inside of the insert.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range.

The products disclosed herein may lack any element that is not specifically disclosed herein. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein can be combined with any other embodiment disclosed herein unless explicitly and directly stated otherwise.

Unless defined otherwise, all technical and scientific terms and any acronyms used herein have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

As used herein, the term “additive” includes one or more of hydrocolloids (e.g. carboxymethylcellulose, methylcellulose, hydroxypropylmethylcellulose, konjac gum, carragenans, xanthan gum, gellan gum, locust bean gum, alginates, agar, gum arabic, gelatin, Karaya gum, Cassia gum, microcrystalline cellulose, ethylcellulose), emulsifiers (e.g. lecithin, mono and diglycerides, PGPR), whitening agents (e.g. titanium dioxide), plasticizers (e.g. glycerine), anti-caking agents (e.g. silicon-dioxide).

All percentages expressed herein are by weight of the total weight of the plant based schnitzel and/or the corresponding emulsion unless expressed otherwise.

The term “conic” refers to the shape of the core of the extrustion die. Preferably, the core is a conic core with a circular symmetry. The core may be an alternative shape. Other forms such as an elliptical cone or a pyramidal cone with multiple edges, for example greater than six, or seven, or eight, or nine, or ten edges, are also possible.

The terms “food,” “food product” and “food composition” mean a plant based schnitzel product or composition that is intended for ingestion by an animal, including a human or pet, and provides at least one nutrient to the animal.

A “schnitzel analogue” or “plant based schnitzel product” resembles schnitzel that has been derived from an animal source, in terms of appearance, texture, and physical structure. As used herein, a plant based schnitzel or schnitzel analogue does not include meat derived from an animal source.

A specific feature of the plant based schnitzel product is the presence of a macroscopic fibrillar protein-based structure.

The plant based schnitzel is preferably made using a cooling die as described herein. The cooling die creates plant based schnitzels with fibres which are formed in the die in a substantially perpendicular direction to the flow path of the die.

In one embodiment, the die comprises an inlet and an outlet, or die exit. The die is preferably a short die, The die may include a line connection that directs a dough into a die inlet. The line connection may be connected to other elements of a meat analogue production system, for example an extrusion device, to receive raw and/or pre-processed meat analogue and/or dough for processing to make a plant based schnitzel product of the invention.

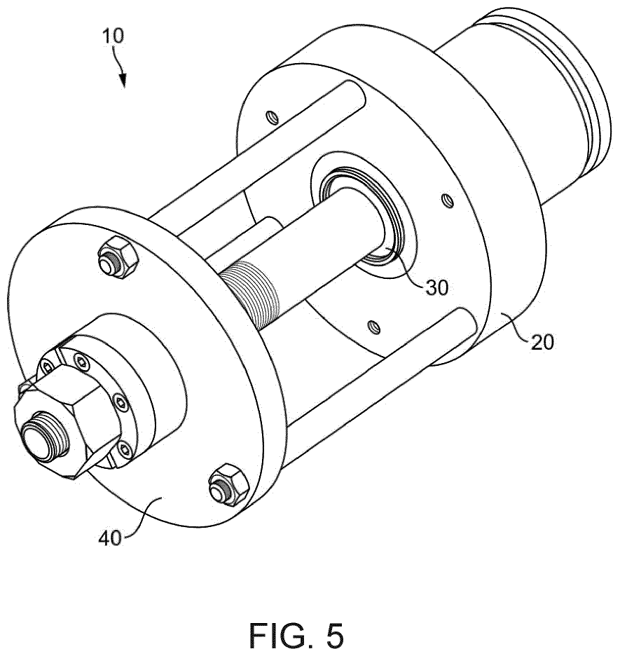

The die comprises an insert, also referred to as the main body, a core, preferably a conic core, and a flow path. Preferably, the die is a short die. Preferably, the die is of the coat hanger type. The coat hanger geometry is characterized by an expansion chamber (27) situated right before the slit exit (26) of the die. This specific geometry allows to create a succession of compression, decompression (27), compression (26) and decompression to the atmospheric pressure which creates a specific fiber bundle. The coat hanger geometry is derived from the plastic film casting die and is characterized by an expansion chamber situated right before the slit exit of the die. This specific geometry allows to create a succession of compression, decompression, compression and decompression to the atmospheric pressure which creates a specific fiber bundle organization. Preferably, the die comprises means to facilitate movement of the core inside the insert. Referring to FIG. 5, the die 10 comprises an insert or main body 20, and a conic core 30. Frame 40 is connected to the conic core 30 and the insert or main body 20 and facilitates movement of the conic core 30 inside the insert or main body 20. Frame 40 provides a concentric spatial relationship between the conic core 30 and the insert or main body 20.

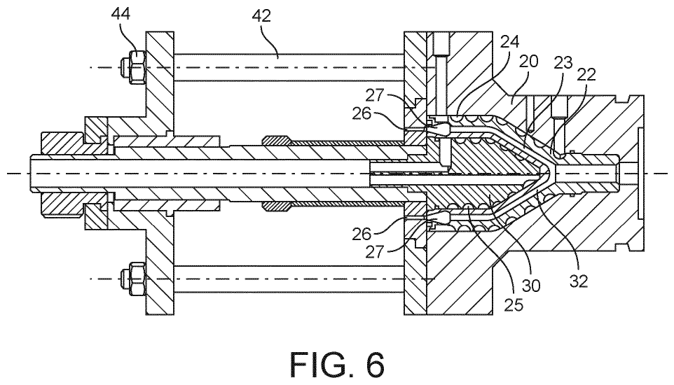

The flow path is the space between the insert or main body and the core. The insert and the core comprise a first interior surface and a second interior surface, respectively. The first interior surface and the second interior surface define the flow path. The insert and/or core comprise a cooling means. Referring to FIG. 6, the insert 20 and the core 30 include a first interior surface 22 and a second interior surface 32, respectively. The first interior surface 22 and the second interior surface 32 define a flow path 23. The flow path 23 represents the route of the dough as it is directed through the die 10. The insert 20 and/or the core 30 comprise a cooling means 24, 25. The cooling means controls the temperature of the dough as it is directed through the die.

The core may comprise a cooling means to control the temperature of the dough. The insert may comprise a cooling means to control the temperature of the dough. Referring to FIG. 6, the cooling means 25 of the core 30 may be controlled independently from the cooling means 24 of the insert 20.

The frame may be connected to the insert by connecting means, for example axes or rods. A positioning means, for example a screw system, may be used to position the core inside the insert. Referring to FIG. 6, the die 10 includes a frame 40. The frame 40 may be connected to the insert 20 by axes 42. The frame 40 provides a concentric spatial relationship between the core 30 and the insert 20. The frame 40 may include a screw system 44. The screw system facilitates movement of the core 30 inside the insert 20. The movement may be parallel to a z geometrical axis of the insert 20. The core 30 and the insert 20 may be fixed at any suitable position to form a flow path 23 between the core 30 and the insert 20.

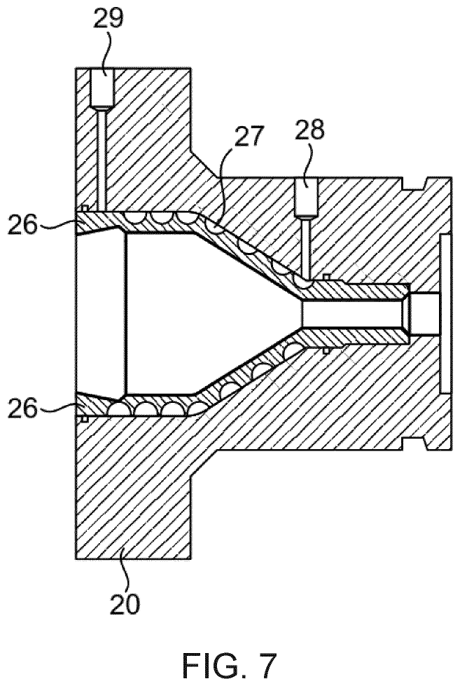

The gap between the core and the insert forms the die exit. Typically, the die exit is circular. Typically, the die exit has a defined gap size. Typically, the die exit has a gap size of between 1.4 to 3.5 mm, for example 2.5 mm. Typically, the die exit has an external perimeter of greater than 400 mm, preferably between 400 mm and 500 mm, for example 450 mm. The core and insert have a concentric spatial relationship. A double helical mantle may be screwed inside the insert. The cooling means may be regulated by a temperature sensor (not shown). Referring to FIG. 7, a gap between the conic core and the insert forms the die exit 26. A double helical mantle 27 may be screwed inside the insert 20. The double helical mantle 27 may have an inlet connection 28 and an outlet connection 29 to a cooling means.

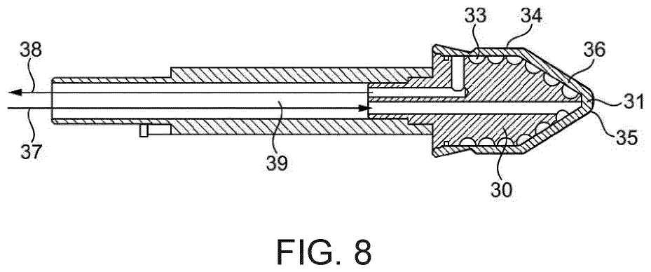

Typically, the core comprises a cylindrical section and a summit end. Typically, the summit end is rounded. The summit end may comprise a helical channel on its surface. A mantle may be adapted to plug on the summit end. The core may be connected to the frame by a central axis. Referring to FIG. 8, the conic core 30 comprises a summit end 31. The summit end 31 is rounded. The summit end 31 has a helical channel 33 on its surface 34. A conic mantle 35 is adapted to plug on the summit end 31 to create a cooling circuit 36 inside the conic core 30 with an inlet connection 37 and an outlet connection 38 to the external cooling. The conic core 30 is connected to the frame by a central axis 39, thereby allowing coolant or cooling fluid to be fed to the conic core cooling circuit 36.

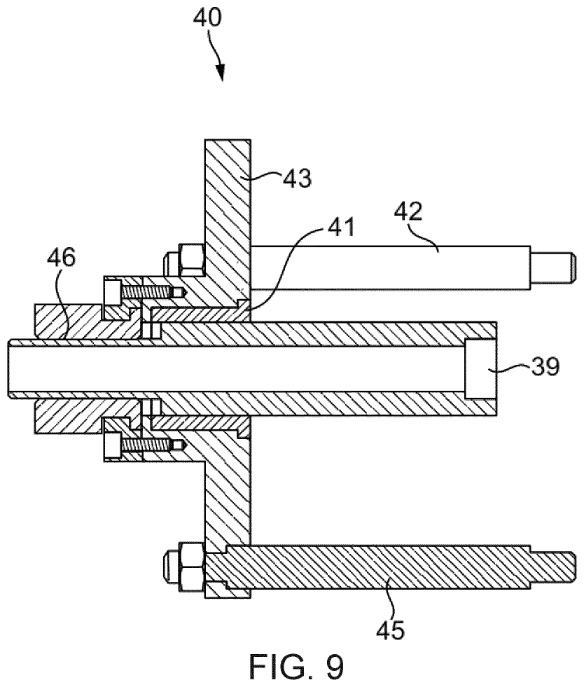

The frame further comprises guiding means, for example a screw thread. This facilitates the accurate positioning of the core inside the insert. The frame and the insert can also be maintained in a fixed position without modification. It also further enables the flow path to be adjusted. Referring to FIG. 9, the frame 40 is composed of a bearing guide 41 inside a flange 43 connected to the insert by three screwed rods 45 with an adapted geometry to set the bearing guide 41 centered to the insert. A central axis 39 may be connected on one side to the conic core and on the other side to the bearing guide 41 with fine thread 46 to allow an accurate positioning of the conic core inside the insert and further enables the flow path to be adjusted.

In an embodiment, the core comprises a cylindrical section and a summit end. The angle of the surface between the cylindrical section of the core and the summit end of the core can be varied, for example the angle of the surface at a point equidistant between the cylindrical section of the core and the summit end of the core can be varied. The angle of the surface between the cylindrical section of the core and the summit end of the core, for example the angle of the surface at a point equidistant between the cylindrical section of the core and the summit end of the core, can be between 100° to 170°, or between 110° to 160°, or between 120° to 150°, or between 130° to 140°, or about 135°. Where the angle is 135° or less, the angle of the surface between the cylindrical section of the core and the summit end of the core, for example the angle of the surface at a point equidistant between the cylindrical section of the core and the summit end of the core, can be between 100° to 135°, or between 105° to 130°, or between 110° to 125°, or between 115° to 120°, or about 117°. Where the angle is 135° or more, the angle of the surface between the cylindrical section of the core and the summit end of the core can be between 135° to 170°, or between 140° to 165°, or between 145° to 160°, or between 150° to 155°, or about 152°.

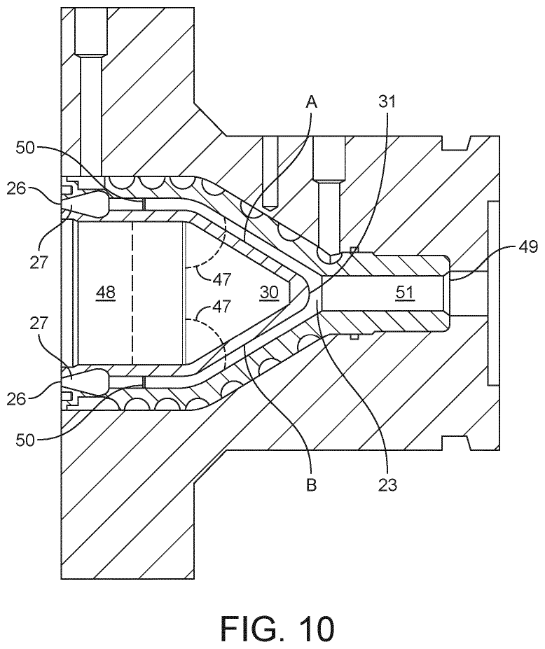

As shown in FIG. 10, the angle 47 of the surface between the cylindrical section of the conic core and the summit end 31 of the conic core 30 can be increased or decreased, thereby adjusting the pressure gradient in the flow path 23. If angle 47 is decreased, for example to equal or less than 135°, the flow path of the dough will widen at the summit end 31 of the conic core 30 and then the dough will increase in pressure as the flow path 23 is reduced. In another embodiment, if angle 47 is increased, for example to equal or greater than 135°, the flow path of the dough will narrow at the summit end 31 of the conic core 30 and then the flow of the dough will widen as the flow path 23 is increased. The diameter 48 of the conic core 30 or the distance 51 from the summit end 31 of the conic core 30 to the die entrance 49 is also adjusted when angle 47 is modified to adjust the gap 50 in the cylindrical section of the conic core 30. By adjusting the values of angle 47, diameter 48, and distance 51, the structure and texture of the resulting product at the die exit 26 can be altered. For example, the expansion, density, and fiber organization can be altered.

In one embodiment, a cutting means cuts the extrudate as it exits the die at one point to obtain a single piece of extrudate. In one embodiment, the cutting means cuts the extrudate as it exits the die at more than one point to obtain more than one piece of extrudate.

The invention further provides a method of making a plant based schnitzel product, the method comprising applying heat and/or pressure to a dough in an extruder; passing the dough through a die that is part of and/or is connected to the extruder, the die comprising an insert, a core, preferably a conic core, and a flow path; wherein the flow path is defined by the insert and the core. Preferably, the die is according to the invention as described herein. Preferably, the die is a short die of the coat hanger type.

In an embodiment, the method further comprises maintaining the insert and/or the conic core at a constant temperature.

In an embodiment, the method further comprises adjusting the constant temperature of the insert and/or the conic core based on temperature information received from a temperature sensor that senses a temperature of the insert and/or the conic core as the dough passes through the flow path.

In an embodiment, the dough is directed through the flow path at a massic flow rate of 20 kg/h to 300 kg/h, preferably 75 kg/h to 300 kg/h.

In an embodiment, the meat analogue comprises fibres which are formed in a substantially perpendicular direction to the flow path of the die. In an embodiment, the values of the ratio of the maximum force to cut the fibres in transversal direction to the maximum force to cut the fibres in longitudinal direction with respect to the direction of the flow path of the die is about 2, more preferably 2 or greater.

In an embodiment, the method further comprising cutting the plant based schnitzel after it exits the die.

The invention further relates to the use of a core, preferably a conic core with a circular symmetry, in a die as described herein to make a plant based schnitzel according to the invention.

The invention further relates to the use of a die as described herein to make a plant based schnitzel according to the invention. Preferably, the invention relates to the use of a die to make a plant based schnitzel according to the invention, wherein said die comprises a conic core with a circular symmetry.

The meat analogue extrusion system may first preprocess the dough at a dough preparation area. For example, the dough may include multiple ingredients, and the multiple ingredients may require mixing prior to further processing. The mixing may be performed by hand and/or may be performed by a mechanical mixer, for example a blender.

The dough may be placed in a pump, for example a piston pump, of the meat analogue extrusion system. The dough may be placed in the pump by hand, and/or may be automatically transported from the dough preparation area to the pump. The pump may transmit the dough through a line. The line may be connected to an extruder. For example, the line may be connected to a twin screw extruder. In an embodiment of the meat analogue extrusion system, the line is not included, and the pump is connected directly to the extruder.

The extruder, for example a twin screw extruder, may apply a pressure to the dough to move the dough from a side of the extruder with the pump to an opposite side of the extruder. The extruder may additionally or alternatively apply heat to the dough. The extruder may additionally or alternatively be configured with an injection port to inject water and/or another material into the dough as the dough moves though the extruder.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims. Further, the present embodiments are thus not to be limited to the precise details of methodology or construction set forth above as such variations and modification are intended to be included within the scope of the present disclosure. Moreover, unless specifically stated any use of the terms first, second, etc. do not denote any order or importance, but rather the terms first, second, etc. are merely used to distinguish one element from another

### EXAMPLES

### Example 1

Comparison with Commercial Plant Based Schnitzels

Plant based schnitzel recipes S04, S10, and SP3.1 were prepared according to the invention, each comprising 10 wt % wheat gluten and 24 wt % pea protein isolate. Each recipe had varying amounts of moisture and precipitated calcium carbonate (PCC) as shown in the table below. All recipes were prepared using an extrusion temperature of 150° C.

| Sample | Moisture (%) | PCC (%) |
|---|---|---|
| S04 | 56.0 | 6.7 |
| S10 | 61.0 | 3.0 |
| SP3.1 | 63.0 | 2.0 |

Other recipes were also developed using 12.5% wheat gluten, 26.5% pea protein isolate, 2% calcium carbonate, 4% of vinegar (10% solution), and 53% water.

The S04 and S10 products each comprised 3 layers of extrudate and had a thickness of 16 mm. The SP3.1 comprised 2 layers of extrudate and had a thickness of 10 mm.

Sensory, texture, and microscopy analysis techniques were able to differentiate S04, S10, and SP3.1 schnitzels from eight commercially available plant based schnitzel products labelled A to H and two commercially available meat based schnitzel products that were tested.

The sensory methodology used RATA (Rate-All-That-Apply) approach was used whereby the nine panelists checked or ticked off all attributes that they would use to describe the sensory characteristics of the samples. Each attribute selected was rated on the 5 points intensity scale (from slightly intense=1 to extremely intense=5). The panel training program comprised 3 sessions. The first session involved a presentation of the glossary, followed five days later with a session involving a scale calibration with meat and vegan schnitzels, followed one week later by a second scale calibration with meat+vegan schnitzels. Each panelist received a serving size of 1 cm×2 cm×2 cm, for each sample in triplicate. The cooking method was deep frying for 2 to 3 minutes in a fryer with sunflower oil.

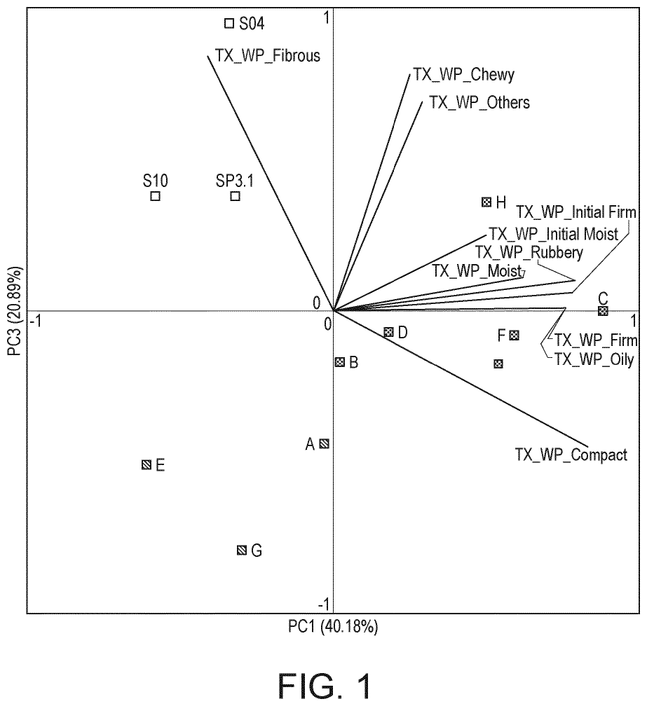

Compared to the competitor products A to H that were tested, the vegan schnitzels according to the invention were significantly more fibrous, significantly less compact, more chewy, and less juicy. The data from sensory analysis are summarized on a PCA biplot (FIG. 1). The products, represented by dots on the map, are clustered according to the results of a product clustering algorithm (K-means). S04, S10, and SP3.1 products are clearly distinct as one particular group, with higher values in the fibrous and chewy direction and inverse to the direction of “compact” descriptor. The commercial products can be classified in two groups, those present above the compact descriptor line (products D, H, F, and C), and those below the compact descriptor line (products B, A, E, and G).

A statistical analysis was performed to characterize product specificities. Analyses of Variance (ANOVAs) were conducted for each sensory or physical measure. Significant differences could be seen between S04, S10, and SP3.1 and the commercial products. The most striking differences were extracted and displayed on x-y graphs for the variables of interest. The correlation between the sensory and texture analyses data confirm the specificity of the S04, S10 and SP3.1 as illustrated in FIG. 1.

Methods of measuring fibrous texture are well known in the art. For example, in De Angelis et al (Foods 2020, 9, 1754; doi:10.3390/foods9121754), the authors assess the fibrous appearance of meat analogs. The number of fibers is assessed visually. Pena-Gonzalez et al (Ital. J. Food Sci., vol 29, 2017, pg 463-475) evaluated the quality of ultrasound-treated beef. In their sensory analysis they also introduced the “fibrous” attribute in the glossary for the texture evaluation in mouth. In Knowles et al (Food Res. Int., vol. 137, 2020, 109655 https://doi.org/10.1016/j.foodres.2020.109655), the fibrousness was also embedded in the texture attributes for sheep meat evaluation.

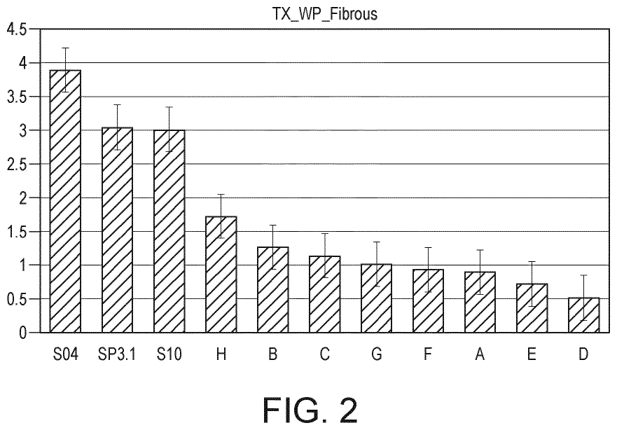

All the texture analysis measures (in particular, maximum load forces and the ratio of the maximal normalized force in the two cutting directions) are strongly related to the difference between S04, S10, SP3.1 compared with the commercial products, and strongly correlated with the fibrous and chewy sensory perceptions. FIG. 2 demonstrates the difference in fibrous sensory attribute between S04, S10, SP3.1 and commercially available products A to H. Product H is known to comprise rehydrated soy and was the most fibrous commercially available product.

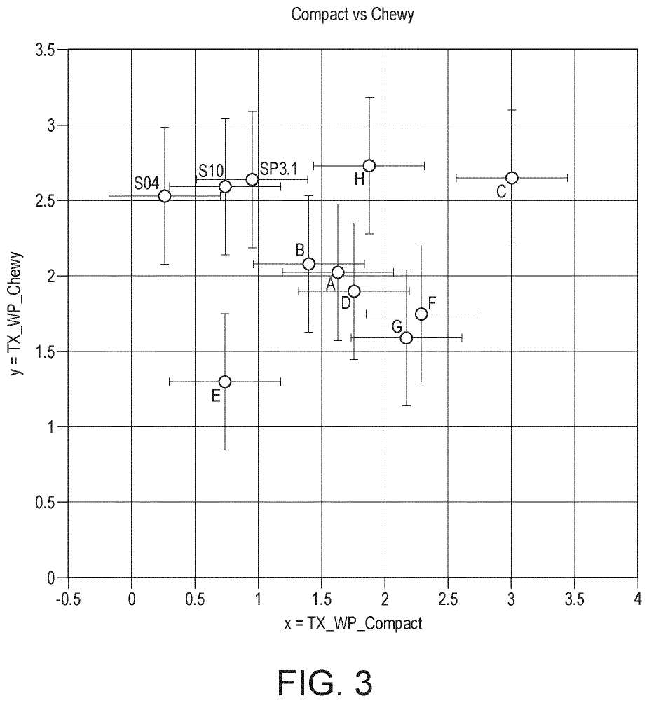

FIG. 3 shows that SP3.1, S04, and S10 all have a compact score of less than 1.2 and a chewy score of more than 2.3. Error bar=½ LSD. If there is no overlap, the difference is significant

Texture analyses were performed with a TAXT.plus equipment from Stable Micro Systems Ltd, Godalming, United Kingdom. A probe with 1 knife cut through the samples. Standard blades from HDP/KS10 with 1.5 mm beveling at 45° and a 50 kg load cell were used. The measurement parameters were: test speed: 1 mm/s, distance: 30 mm, trigger force: 0.100N.

A total of 10 samples per variant were analyzed, each having a 4×8 cm dimension. Two cutting directions were used for each sample (1—cutting across fibres (transversal) and 2—cutting along fibres (longitudinal)). This allowed to measure whether the fibers were aligned in a preferred direction as seen in a real meat structure. Maximal load force was recorded for each measurement. The average and standard deviation calculated for each sample. The analyzed products were of varying thickness and so the maximum load forces values were normalized by the thickness value, i.e. the maximum load forces values were divided by measured thickness.

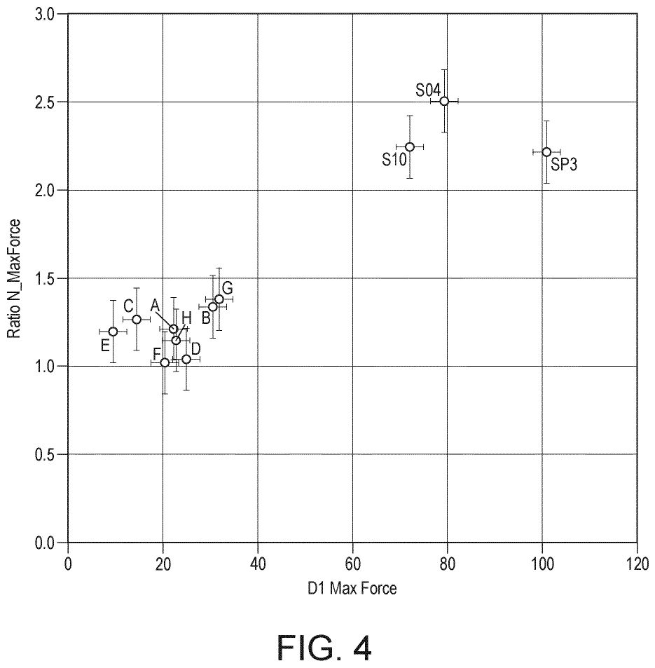

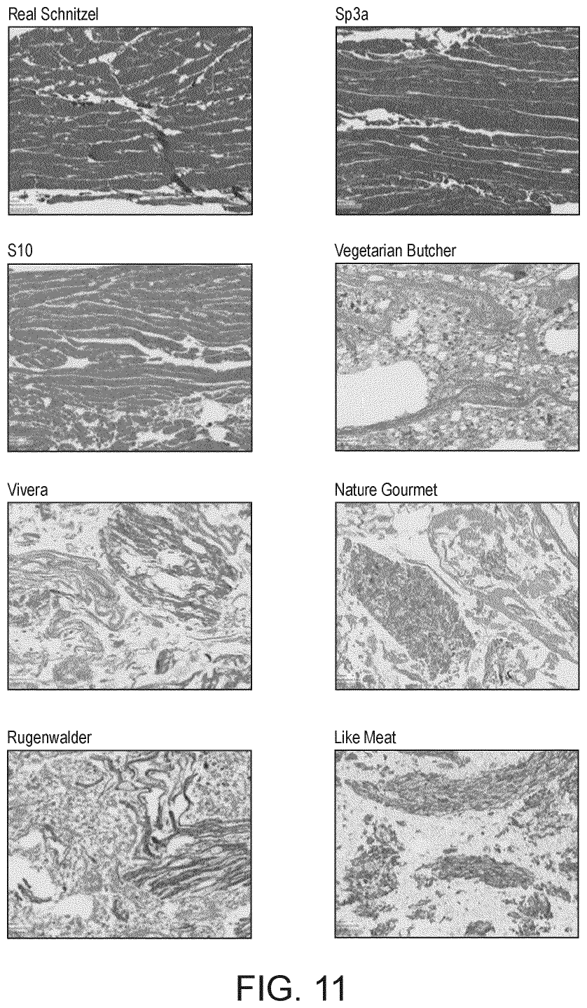

FIG. 4 shows that S04, S10, and SP3.1 have a much higher normalized transversal cutting force compared to commercial products and a ratio between the normalized maximum force in the transversal direction to the normalized maximum force in the longitudinal direction superior to a score of 1.55. Microscopy analysis were performed with histology preparation. Sample preparation were performed according to Standard histological preparation with paraffine embedding according to norm ISO NF 04-417. FIG. 11 shows the structure of the schnitzel transversal cut through the fiber direction. The samples SP3a and S10 produced with the invention method have clearly a structure which is more similar to the real meat schnitzel structure as compared to the structure of the commercial prior art schnitzel analogues. The main difference is the structure of the meat analogues obtained with the method of the present invention which shows fibres bundles which are continuous on a long length on several millimetres as in the real meat while the prior art meat analogues present non oriented fibrous structure on a short distance. These differences as compared to prior art meat analogues explain the advantage of the meat analogue obtain with the present invention with a closer to the real meat in mouth perception in term of firmness, chewiness, and compactness properties.

### Example 2

The same recipes as example 1 were prepared except that the extrudates each comprised 10 wt % wheat gluten and 24 wt % soy protein concentrate or soy protein isolates.

1. A plant based schnitzel product, said product comprising
a. a plant protein based extrudate comprising at least two different plant proteins;
b. a breaded coating surrounding the plant protein based extrudate;
wherein said plant protein based extrudate comprises fibres which are aligned in substantially the same direction; and
wherein the plant protein based extrudate is present as a single extruded slab or as a layer of two or more extruded slabs.

2. A plant based schnitzel product according to claim 1, wherein the ratio of nominal maximal force values required to cut the product perpendicular to the fibre direction compared to parallel or along the fibre direction is greater than 1.55.

3. A plant based schnitzel product according to claim 1, wherein the product has a compact score of less than 1.2 and a chewy score of more than 2.3.

4. A plant protein based schnitzel product according to claim 1, wherein a binding agent is present between the layer of two or more extruded slabs.

5. A plant protein based schnitzel product according to claim 1, wherein the plant proteins are wheat gluten and a pea protein.

6. A plant protein based schnitzel product according to claim 1, wherein the product comprises 5 to 15 wt % wheat gluten and 19 to 29 wt % pea protein.

7. A plant protein based schnitzel product according to claim 1, wherein the product comprises 5 to 15 wt % wheat gluten and 19 to 29 wt % soy protein.

8. A plant protein based schnitzel product according to claim 1, wherein the plant protein based extrudate further comprises insoluble particles.

9. A plant protein based schnitzel product according to claim 1, wherein the plant protein extrudate further comprises flavoring.

10. A method of making a plant based schnitzel product, said method comprising
a. Feeding an extruder barrel with a composition comprising at least two different proteins and water;
b Extruding the composition at a maximum temperature of between 130 to 190° C.;
c. Cooling the composition through a die;
d. Cutting the composition to form a slab;
e. Cooking the slab or arranged layer of slabs to form a cooked slab or arranged layers of slab; and
f. Applying a breaded coating to the cooked slab or cooked arranged layers of slab.

11. A method of making a plant based schnitzel product, comprising using a conic short coat hanger die to extrude the product.

12. The method according to claim 10, wherein the composition comprises between 55 to 65 wt % water.

13. The method according to claim 10, wherein the slab or arranged layer of slabs are compressed prior to or during cooking.

14. The method according to claim 10, wherein a binding solution is applied between the arranged layer of slabs.

15. The method according to claim 14, wherein the binding solution comprises soy protein isolate.

16. The method according to claim 14, wherein the binding solution comprises about 12% soy protein isolate and about 10% transglutaminase in a 1:1 mixture.

17. The method according to claim 14, wherein the binding solution comprises soy protein isolate, wheat flour and starch.

18. The method according to claim 14, wherein flavoring is added with the binding solution or by injecting into the slab.

19. The method according to claim 14, wherein the slabs are cooked at about 45° C. and then at about 90° C.

20. (canceled)
